(19) United States
(12) Patent Application Publication
(10) Pub. No.: US 2011/0067088 A1
(43) Pub. Date: Mar. 17, 2011

(54) IMAGE PROCESSING DEVICE, INFORMATION PROCESSING METHOD, AND RECORDING MEDIUM

(75) Inventor: Kiyohiro HYO, Kanagawa (JP)

(73) Assignee: RICOH COMPANY, LTD., Tokyo (JP)

(21) Appl. No.: 12/879,083

(22) Filed: Sep. 10, 2010

(30) Foreign Application Priority Data
Sep. 14, 2009 (JP) 2009-212449
May 18, 2010 (JP) 2010-114672

(51) Int. Cl. G06F 9/46; G06F 21/00; G06F 15/16

(52) U.S. Cl. 726/3; 719/328

(57) ABSTRACT

In an image processing device which is configured to use plug-ins to provide services, a service managing part manages services, plug-ins of which are implemented. A common control part controls common processes of a requested service in response to a service execution request with respect to one of the services. A common process part performs common processes for the respective services. An individual process part performs an individual process in the common processes, the individual process being implemented as a plug-in. The common process part includes an individual-process managing part which manages the individual process associated with one of the services.

### BACKGROUND OF THE INVENTION

1. Field of the Invention

The present disclosure relates to an image processing device, an information processing method, and a recording medium.

2. Description of the Related Art

Conventionally, when a new tool which is different from the currently implemented tools is implemented in an image processing device which uses plug-ins to provide Web services, the image processing device uses a new protocol and interface which are different from the currently used protocols and interfaces, in order to implement the new tool. FIG. 1 illustrates the composition of an image processing device according to the related art.

As illustrated in FIG. 1, in the image processing device according to the related art, a tool-A interface, a tool-A process, a tool-B interface, and a tool-B process are implemented individually. This is because authentication processes performed by the tool A and the tool B are different from each other, or data transmitted or received by the tool A and the tool B are of different formats.

However, the image processing devices and client devices in the network must be arranged to deal with the respective protocols and the respective interfaces. The portion of the software in which the same processes are performed must be developed in a duplicate manner. As a result, the time and effort for the development of the duplicate software have been spent in vain.

To eliminate the problem, various service provision systems have been developed in order to integrate the interfaces. For example, Japanese Laid-Open Patent Publication No. 2006-127222 discloses an on-demand service provision system which analyzes a service request from a client device, performs a common process with respect to the service request, and carries out the requested service.

However, common processes of Web services in the image processing device according to the related art are common to the respective services, and the image processing device according to the related art is unable to customize individual processes in the common processes for respective services.

### SUMMARY OF THE INVENTION

In one aspect, the present disclosure provides an image processing device, an information processing method, and a computer-readable recording medium which are capable of customizing individual processes for respective services in common processes of Web services.

In an embodiment which solves or reduces one or more of the above-mentioned problems, the present disclosure provides an image processing device which is configured to use plug-ins to provide services, the image processing device including: a service managing part to manage services, plug-ins of which are implemented; a common control part to control a common process of a requested service in response to a service execution request with respect to one of the services; a common process part to perform common processes for the respective services; and an individual process part to perform an individual process in the common processes, the individual process being implemented as a plug-in, wherein the common process part includes an individual-process managing part which manages the individual process associated with one of the services.

In an embodiment which solves or reduces one or more of the above-mentioned problems, the present disclosure provides an information processing method for use in an image processing device which is configured to use plug-ins to provide services and includes a service managing part which manages services, plug-ins of which are implemented, and an individual-process managing part which manages an individual process in common processes for the respective services, the information processing method including: receiving, by a common control part, a service execution request with respect to one of the services; searching, by the common control part, the one of the services in the service managing part and searching an individual process part associated with the one of the services in the service managing part; sending, by the common control part, a common process execution request to the individual process part; causing, by the individual process part, a common process part to perform common processes of the one of the services; determining, by the common process part, which individual process is to be performed by accessing the individual-process managing part; performing, by the individual process part, the individual process; and causing, by the individual process part, a service part to perform the one of the services.

Other objects, features and advantages of the present disclosure will become more apparent from the following detailed description when read in conjunction with the accompanying drawings.

### BRIEF DESCRIPTION OF THE DRAWINGS

FIG. 1 is a diagram illustrating the composition of an image processing device according to the related art.

FIG. 2 is a diagram illustrating the composition of a system to which an image processing device of an embodiment of the present disclosure is applied.

FIG. 3 is a block diagram illustrating the hardware composition of an image processing device of an embodiment of the present disclosure.

FIG. 4 is a block diagram illustrating the basic functional composition of an image processing device of an embodiment of the present disclosure.

FIG. 5 is a block diagram illustrating the functional composition of an image processing device of a first embodiment of the present disclosure.

FIG. 6 is a diagram illustrating an example of individual-process management data in the first embodiment.

FIG. 7 is a sequence diagram for explaining a service registration process which is performed by the image processing device of the first embodiment.

FIG. 8 is a sequence diagram for explaining a service A process which is performed by the image processing device of the first embodiment.

FIG. 9 is a block diagram illustrating the functional composition of an image processing device of a second embodiment of the present disclosure.

FIG. 10 is a diagram illustrating an example of individual-process management data in the second embodiment.

FIG. 11 is a sequence diagram for explaining a service A process which is performed by the image processing device of the second embodiment.

FIG. 12 is a sequence diagram for explaining a service C process which is performed by the image processing device of the second embodiment.

FIG. 13 is a block diagram illustrating the functional composition of an image processing device of a third embodiment of the present disclosure.

FIG. 14 is a block diagram illustrating the functional composition of an image processing device of a fourth embodiment of the present disclosure.

FIG. 15 is a diagram for explaining the outline of a marking service.

FIG. 16 is a diagram illustrating an example of a plug-in in the fourth embodiment.

FIG. 17A and FIG. 17B are diagrams illustrating examples of individual processes for different reading methods.

FIG. 18 is a sequence diagram for explaining a process which is performed by the image processing device of the fourth embodiment when a marking service is performed.

FIG. 19 is a flowchart for explaining a process which determines individual processes in the common processes.

FIG. 20 is a flowchart for explaining a marking service process which is performed by the image processing device of the fourth embodiment.

### DETAILED DESCRIPTION OF THE PREFERRED EMBODIMENTS

A description will be given of embodiments of the present disclosure with reference to the accompanying drawings.

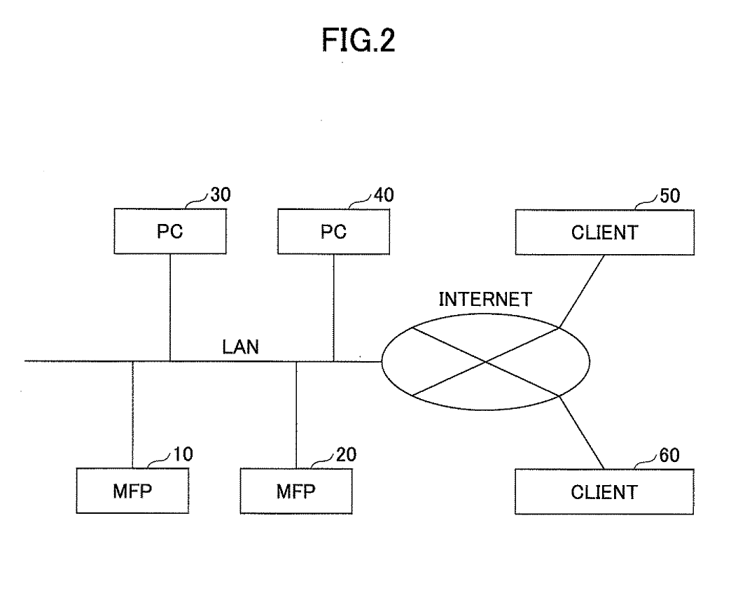

FIG. 2 illustrates the composition of a system to which an image processing device of an embodiment of the present disclosure is applied.

In the system illustrated in FIG. 2, an MFP (which is the abbreviation of multi-function peripheral and will be referred to as image processing device) 10, an MFP 20, a PC (personal computer) 30, and a PC 40 are interconnected via a LAN (Local Area Network). A client PC (which will be referred to as a client) 50 and a client PC 60 are connected to the LAN via the Internet.

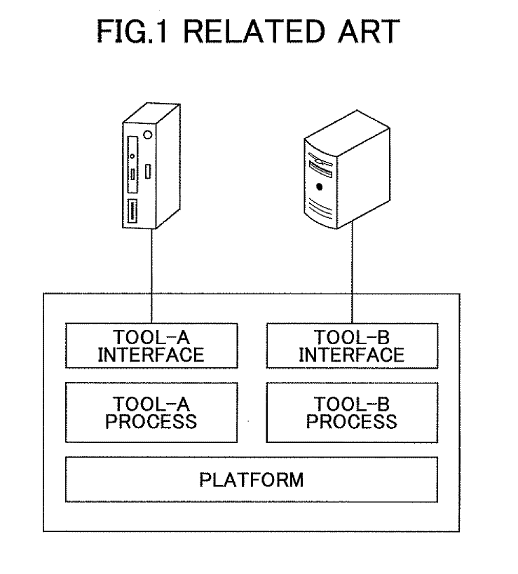

Thereby, each of the PCs 30 and 40 and the clients 50 and 60, connected to the LAN, outputs a service request to one of the MFP 10 and the MFP 20 and receives a response from the one of the MFP 10 and the MFP 20. The system to which the image processing device according to the present disclosure is applied is not limited to the example illustrated in FIG. 1. An arbitrary number of devices may be connected to the system via arbitrary networks, respectively.

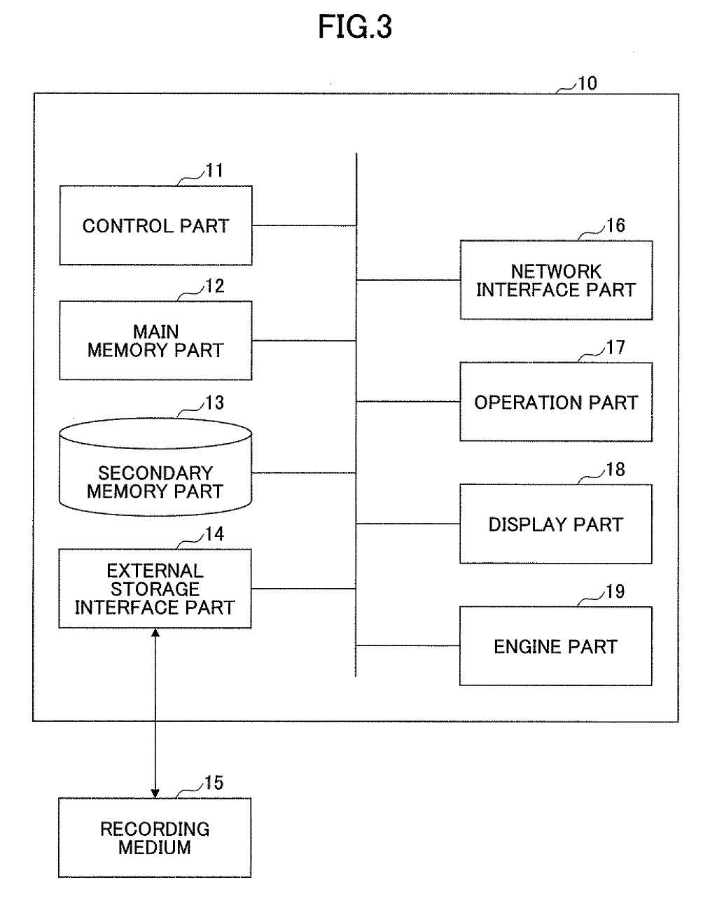

Next, the hardware composition of an image processing device according to the present disclosure will be described. FIG. 3 illustrates the hardware composition of an image processing device 10 of an embodiment of the present disclosure.

As illustrated in FIG. 3, the image processing device 10 includes a control part 11, a main memory part 12, a secondary memory part 13, an external storage interface part 14, a network interface part 16, an operation part 17, a display part 18, and an engine part 19.

The control part 11 includes a CPU which performs control of the components of the image processing device 10, and computations and processing of data in the image processing device 10. The control part 11 includes a processor unit (CPU) which executes a program stored in the main memory part 12 or read from the secondary memory part 13. The processor unit receives data from an input unit or a memory unit, performs processing and computations of the received data, and outputs the resulting data to an output unit or a memory unit.

The main memory part 12 includes a ROM (read only memory), a RAM (random access memory), etc. The main memory part 12 stores or temporarily stores data and programs including the OS (operating system) and application programs which are executed by the control part 11.

The secondary memory part 13 includes a HDD (hard disk drive). The secondary memory part 13 stores the data relevant to the application programs.

The external storage interface part 14 provides an interface between the image processing device 10 and a recording medium 15 (for example, a flash memory, an SD card, etc.) which is connected to the image processing device 10 via a data transmission line, such as USB (universal serial bus), provided in the external storage interface part 14.

In the recording medium 15, a predetermined program is stored beforehand. The predetermined program is read from the recording medium 15 and installed in the image processing device 10 by the control part 11 through the external storage interface part 14. After the installation, the predetermined program can be executed by the control part 11 of the image processing device 10 to perform one or more of the processes which will be described later in the following embodiments.

The network interface part 16 provides an interface between the image processing device 10 and a peripheral device having a communication function connected to the image processing device 10 via the wired or wireless network, such as LAN (local area network) or WAN (wide area network).

The operation part 17 and the display part 18 constitute an operation panel which provides a user interface (UI) which includes a menu or list indication and an input portion for a user to input a selection of the menu or list indication for using any of the image formation functions of the image processing device 10. The operation part 17 includes various kinds of hard keys including selection switches to select each of the functions, and the display part 18 includes a LCD (liquid crystal display) unit having a touch-panel function (including GUI (graphical user interface) software keys).

The engine part 19 provides the image formation hardware parts which actually perform image formation processes, such as a plotter and a scanner.

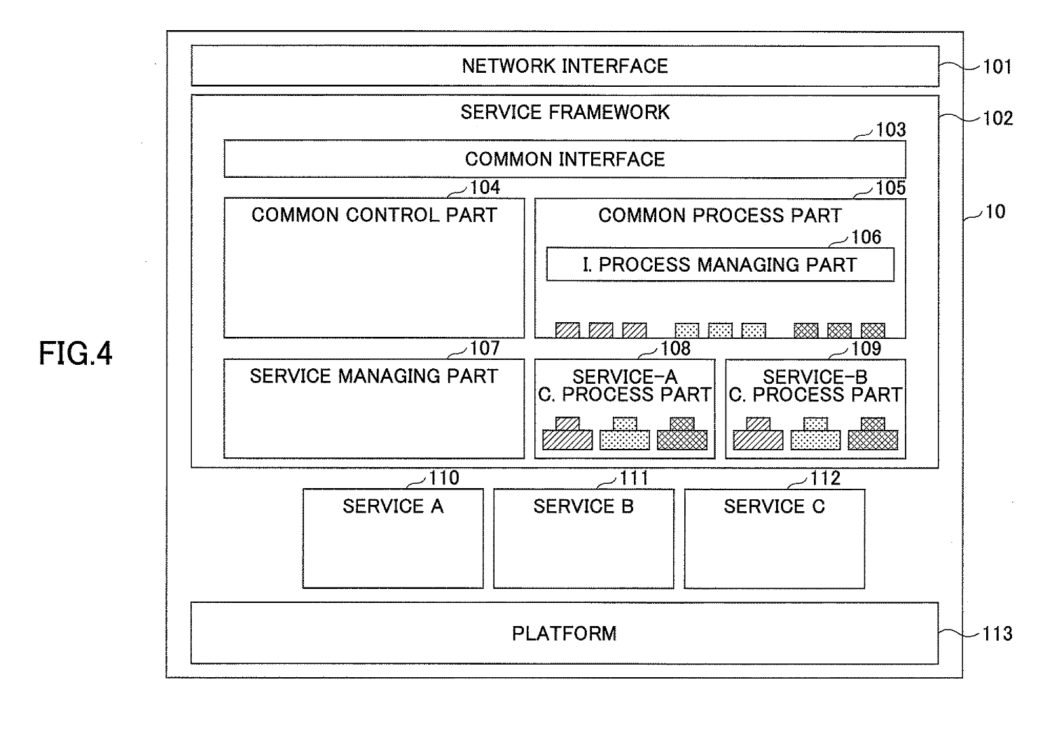

FIG. 4 illustrates the basic functional composition of an image processing device 10 of an embodiment of the present disclosure.

As illustrated in FIG. 4, the image processing device 10 of this embodiment includes a network interface 101, a service framework 102, a service A 110, a service B 111, a service C 112, and a platform 113. In the embodiment illustrated in FIG. 4, the image formation functions of the image processing device 10, such as a copy function, a fax function, a print function, etc., are omitted for the sake of convenience.

In the following, the functions of the network interface 101 are provided by the interaction of the control part 11 and the network interface part 16, and the respective functions of the service framework 102, the services 110-112 and the platform 113 are provided by the control part 11 which executes the corresponding programs stored in the main memory part 12 or the secondary memory part 13.

The network interface 101 provides an interface for connecting the image processing device 10 and the LAN. The service framework 102 generally includes a common interface 103, a common control part 104, a common process part 105, a service managing part 107, a service-A common process part 108, and a service-B common process part 109.

The service framework 102 provides a mechanism for managing the plug-ins which use the respective services. A service can be used by a plug-in when the plug-in associated with the service is registered in the service framework 102. The service framework 102 performs management of the plug-ins, common processes of the services, and control of the calls of individual processes.

The common interface 103 provides an interface common to the respective services. If a service execution request is received from the network interface 101, the common interface 103 sends the service execution request to the common control part 104.

If a service execution request is received from the common interface 103, the common control part 104 searches the requested service in the service managing part 107, in order to determine whether the service can be provided to the requesting source. When the service in the service managing part 107 is searched, the common control part 104 requests the common process part 105 to execute the common process of the service.

If there are the process parts in which the common processes for the respective services are included, the common control part 104 requests the relevant process part to execute the common process for the requested service.

If a common process execution request is received from the common control part 104, the common process part 105 performs the requested common process and sends an inquiry about whether any individual process exists to the individual-process managing part 106. When an individual process exists in the individual-process managing part 106, the common process part 105 performs the individual process. An individual process can be implemented in the image processing device 10 as a single plug-in. The common process part 105 provides a plug-in interface for processing the plug-in of the individual process and provides a mechanism for executing the plug-in to perform the individual process.

The individual process managing part 106 manages the individual processes for respective services in the common processes. Specifically, the individual-process managing part 106 holds and manages the individual-process management data which will be described later.

The service managing part 107 manages the services the plug-ins of which are implemented in the image processing device 10. Specifically, the service managing part 107 holds and manages the service identifiers which respectively identify the services the plug-ins of which are implemented in the image processing device 10.

The service-A common process part 108 is a process part which is inherited from the common process part 105 to include the common process and/or the individual process of the service A. The service-B common process part 109 is a process part which is inherited from the common process part 105 to include the common process and/or the individual process of the service B. When individual processes which are performed in common for two or more services exist, such individual processes may be included beforehand as a common process of the respective services. Therefore, the service-A common process part 108 may be used for another service. It is not necessary to include the individual processes for the respective services in these process parts, and the individual processes may be simply stored in a database.

Each of the service A 110, the service B 111, and the service C 112 may be implemented as a plug-in. Extension, addition, deletion, etc. of functions may be carried out easily. The platform 113 is a plug-in platform which is used when each service or each application program which is implemented as a plug-in is operated.

Examples of services may include an operation (service) of device setup information acquisition, an address book operation, an operation of one of a copy plug-in, a fax plug-in, a print plug-in, etc. A request of an operation to acquire setup information of a device may be expressed as follows.

//ws/machineA/get/id/pas

In the above request, “get” denotes acquisition of setup information of machine A, and “id” and “pas” are parameters used for an authentication process.

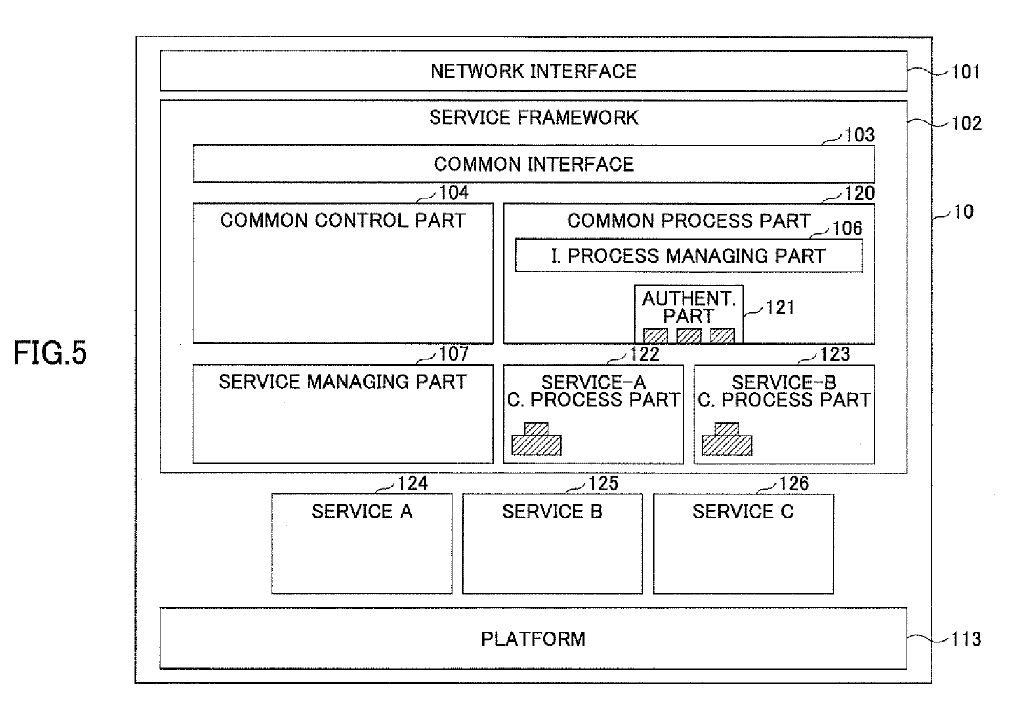

Next, an authentication process will be described. FIG. 5 illustrates the functional composition of an image processing device 10 of a first embodiment of the present disclosure. In FIG. 5, the elements which are the same as corresponding elements in FIG. 4 are designated by the same reference numerals, and a description thereof will be omitted.

As illustrated in FIG. 5, a common process part 120 includes an authentication part 121 which performs common processes of the authentication of each service. In the authentication part 121, the portion which is performed in common for each service when the authentication is performed is implemented. For example, the authentication part 121 performs a receiving process which receives a request, a dispatch process, and an error process when the data needed for authentication is not presented, etc. Individual processes of the authentication are implemented as individual process plug-ins.

The service-A common process part 122 performs an individual process of the authentication of the service A 124. For example, the individual process of the authentication of the service A 124 is a basic authentication which is performed using an ID and a password. The service-B common process part 123 performs an individual process of the authentication of the service B 125. For example, the individual process of the authentication of the service B 125 is Kerberos authentication which is performed by an external authentication server.

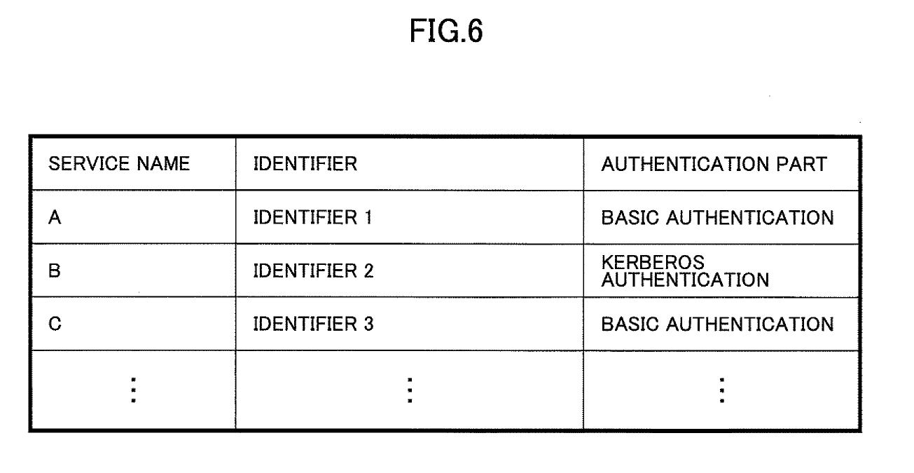

In the individual process managing part 106, services and authentication parts (individual processes) which are used for the respective services are associated with each other and managed with respect to each service. FIG. 6 illustrates an example of individual-process management data in the first embodiment.

As illustrated in FIG. 6, the individual process management data provides associations of individual processes for respective services. Specifically, in the example of FIG. 6, a service name, an identifier (for example, URI (Uniform Resource Identifier)) of the service, and an authentication part of the service are associated together for management of the respective services. The service A 124 and the service C 126 are performed by using the basic authentication which is the same authentication part. The service B is performed by using the Kerberos authentication.

The common process part 120 accesses the individual-process management data managed by the individual-process managing part 106, and determines a particular authentication part to be performed for a particular individual process. The authentication process for each service is carried out by the common process part 120 which performs the common process of the authentication and causes the authentication part (which is implemented as the individual process plug-in) to perform the individual process of the authentication.

Accordingly, when the authentication process is performed, the common process part 120 may perform the common processes common to the respective services, and the particular authentication part may be implemented as an individual process plug-in.

An encryption process and a decryption process are other examples of the common processes. Because there are two or more particular encryption parts, one of the encryption parts may be set to an individual process and may be implemented as a plug-in.

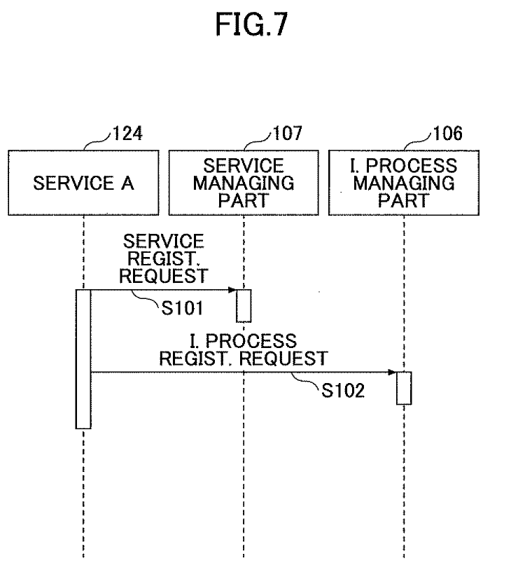

Next, operation of the image processing device 10 of the first embodiment will be described. First, a service registration process in which a service is registered in the service managing part 107 will be described. FIG. 7 is a sequence diagram for explaining a service registration process which is performed by the image processing device of the first embodiment.

As illustrated in FIG. 7, when the plug-in of the service A 124 is installed in the image processing device 10, in step S101, the service A 124 sends a service registration request to the service managing part 107. When an individual process is included in the common processes, in step S102, the service A 124 sends a registration request of the individual process to the individual-process managing part 106. In the step S102, the sending of an individual-process registration request is repeated for the number of individual processes included in the common processes.

Accordingly, the service, the plug-in of which is newly installed in the image processing device 10, is registered and managed by the service managing part 107, and the individual processes in the common processes are registered and managed by the individual-process managing part 106.

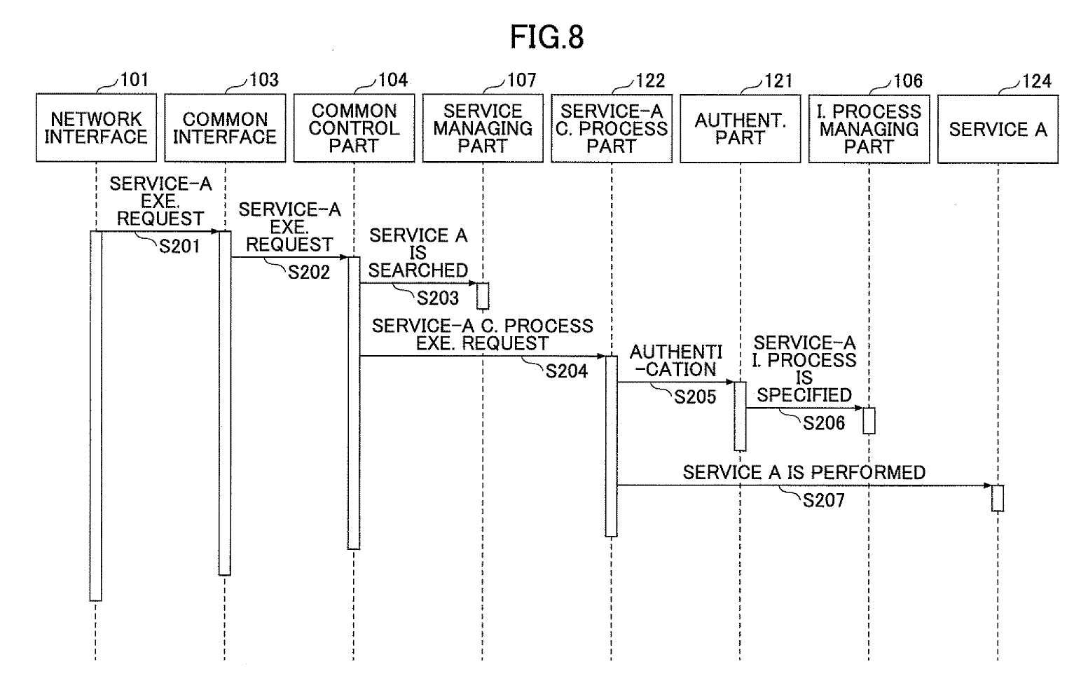

Next, a service process which is performed by the image processing device of the first embodiment will be described. FIG. 8 is a sequence diagram for explaining a service process which is performed by the image processing device of the first embodiment.

As illustrated in FIG. 8, in step S201, the network interface 101 sends a service execution request of the service A to the common interface 103. At this time, the parameters for authentication are also assigned to the service execution request.

In step S202, the common interface 103 sends a service execution request of the service A to the common control part 104 in response to the service execution request received from the network interface 101.

In step S203, the common control part 104 searches the service A in the service managing part 107 in response to the service execution request A received from the common interface 103. When the service managing part 107 manages the service A and the service-A common process part 122 is provided, the service-A common process part 122 is also associated with the service A and managed by the service managing part 107. In the step S203, the common control part 104 searches the service-A common process part 122 in the service managing part 107.

In step S204, the common control part 104 sends a common process execution request of the service A to the service-A common process part 122.

In step S205, in performing an authentication process, the service-A common process part 122 first causes the authentication part 121 of the common process part 120 to perform the common processes of the authentication.

After the common processes of the authentication are performed, in step S206, the authentication part 121 accesses the individual-process managing part 106 and determines which individual process of the authentication is to be performed (see FIG. 6). The service-A common process part 122 performs the individual process (in the example of FIG. 6, the basic authentication) of the authentication of the service A. The individual process of the authentication is performed by calling the required information (user ID and password) of the image processing device for authentication.

After the individual process of the authentication is done successfully, in step S207, the service-A common process part 122 sends a service execution request of the service A to the service A 124 so that the requested service is performed by the service A 124.

Accordingly, according to the image processing device of the first embodiment, the common processes for respective services are included in the common process part, and the individual processes for respective services can be included in the service common process parts. Moreover, according to the image processing device of the first embodiment, the individual processes for respective services are included in the service common process parts, and the individual processes can be used for performing another service.

Next, an image processing device of a second embodiment of the present disclosure will be described. In the second embodiment, a pre-process part and a post-process part are provided as common processes of services, and a predetermined timing to perform each process is specified.

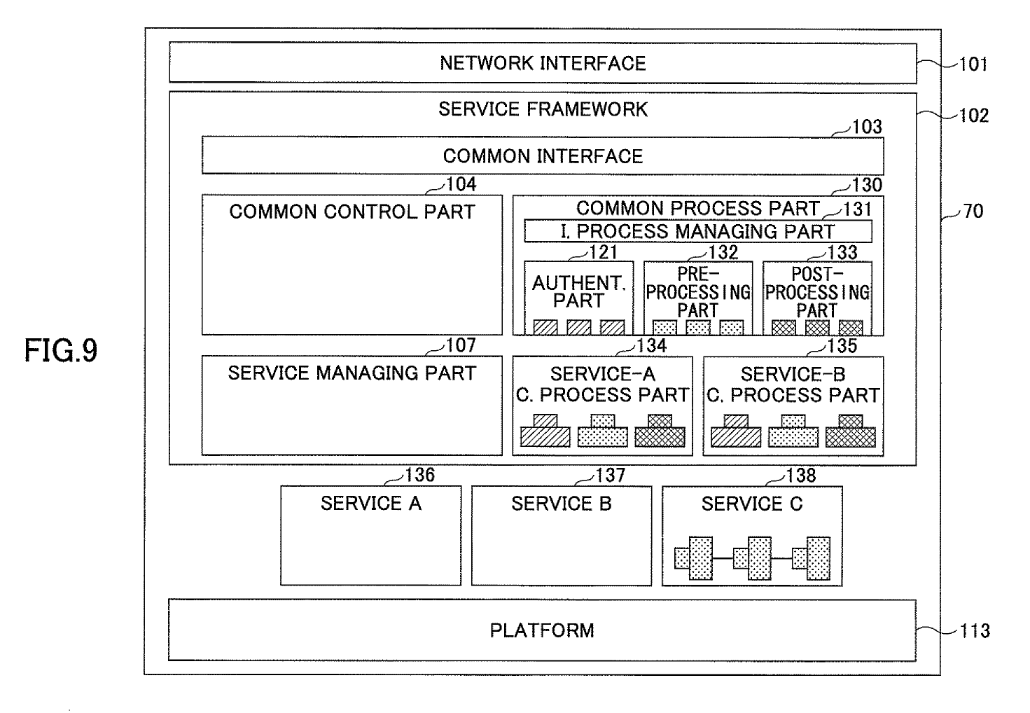

FIG. 9 illustrates the functional composition of an image processing device 70 of the second embodiment. In FIG. 9, the elements which are essentially the same as corresponding elements in FIG. 4 or FIG. 5 are designated by the same reference numerals, and a description thereof will be omitted.

As illustrated in FIG. 9, a common process part 130 includes an individual-process managing part 131, an authentication part 121, a pre-process part 132, and a post-process part 133. In the pre-process part 132, a pre-processing needed for each service is implemented. In the post-process part 133, a post-processing needed for each service is implemented.

In the individual-process managing part 131, not only the individual authentication part for the service but also the pre-process part and the post-process part are associated and managed.

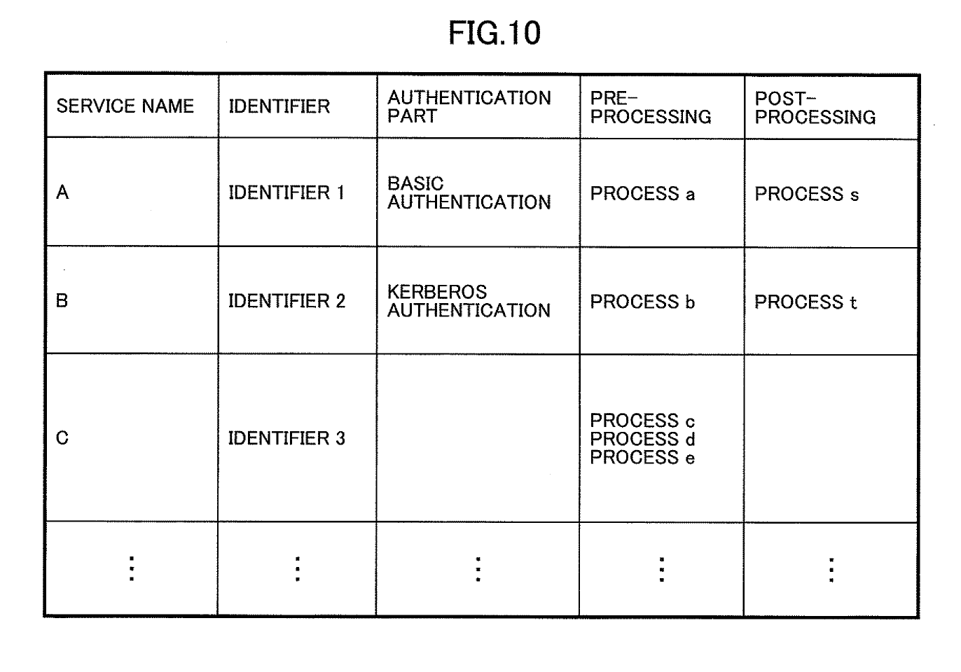

FIG. 10 illustrates an example of the individual-process management data in the second embodiment. As illustrated in FIG. 10, a service name, an identifier (for example, URI), an authentication part, a pre-processing, and a post-processing are associated together for management of the respective services. For example, when the service A is performed, the basic authentication is performed as the authentication part, the process “a” is performed as the pre-processing of the service A, and the process “b” is performed as the post-processing of the service A.

As for the service C, the authentication part and the post-processing are not associated, but the process “c”, the process “d”, and the process “e” are associated as the pre-processing. Examples of the pre-processing may include processing which checks the parameters obtained with an execution request against the device information, processing which calls an instance, etc.

Referring back to FIG. 9, the service-A common process part 134 is a process part which is inherited from the common process part 130 to include individual processes in the common processes of the service A, the individual processes including the authentication part, the pre-processing part, and the post-processing part. The service-B common process part 135 is essentially the same as the service-A common process part 134.

In a case of the service A 136 or the service B 137, after the authentication process is performed, the pre-processing and the service are performed, and then the post-processing is performed. In a case of the service C138, the authentication process is not managed by the individual-process managing part 131 (refer to FIG. 10). In this case, after a default authentication process is performed, the three processes the processing order of which is specified are performed as the pre-processing, and then the service C 138 is performed.

Next, operation of the image processing device 70 of the second embodiment will be described.

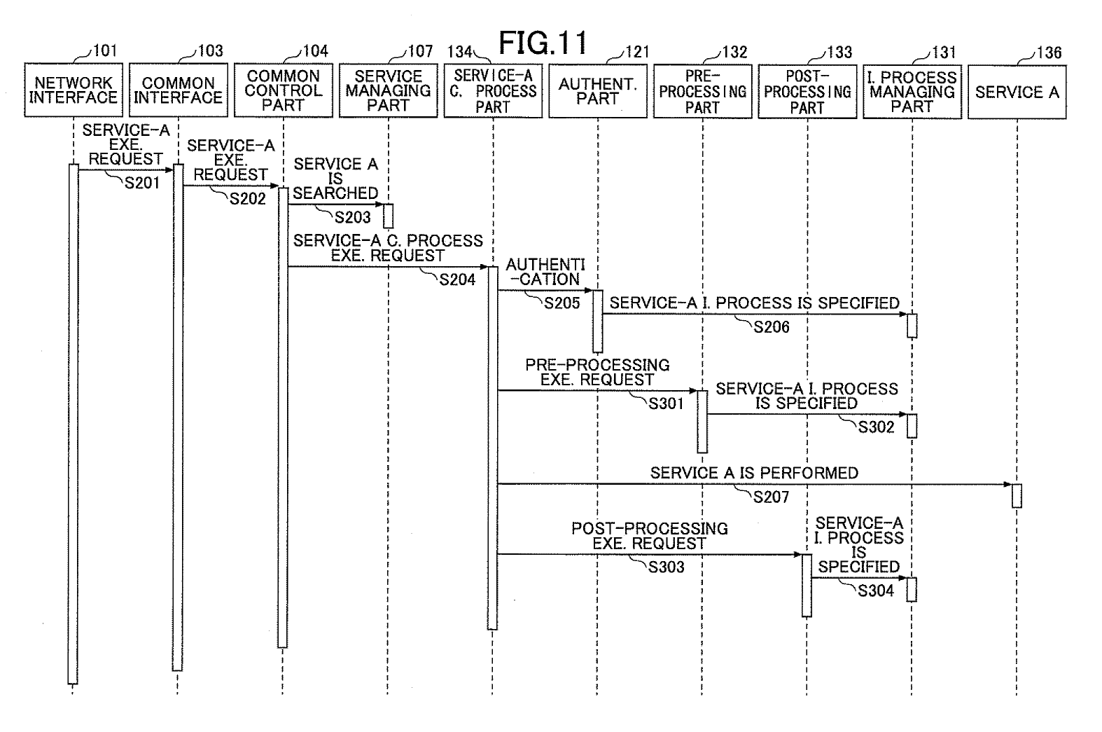

FIG. 11 is a sequence diagram for explaining the service A process which is performed by the image processing device 70 of the second embodiment. In FIG. 11, the steps which are essentially the same as corresponding steps (the steps S201 to S206) in FIG. 8 are designated by the same reference numerals, and a description thereof will be omitted.

As illustrated in FIG. 11, in step S301, the service-A common process part 134 sends a pre-processing execution request to the pre-process part 132 of the common process part 130. In step S302, the pre-process part 132 sends an inquiry about which pre-processing is to be performed for the service A 136 to the individual-process managing part 131, and performs the pre-processing managed by the individual-process managing part 131.

After the pre-processing is performed in the step S302, the service A 136 is performed in the step S207.

After the service A 136 is performed, in step S303, the service-A common process part 134 sends a post-processing execution request to the post-process part 133. In step S304, the post-process part 133 sends an inquiry about which post-processing is to be performed for the service A 136 to the individual-process managing part 131, and performs the post-processing managed by the individual-process managing part 131.

As described above, the pre-processing and the post-processing needed before and after a service is performed can be implemented as individual processes for the service in the common processes of the service.

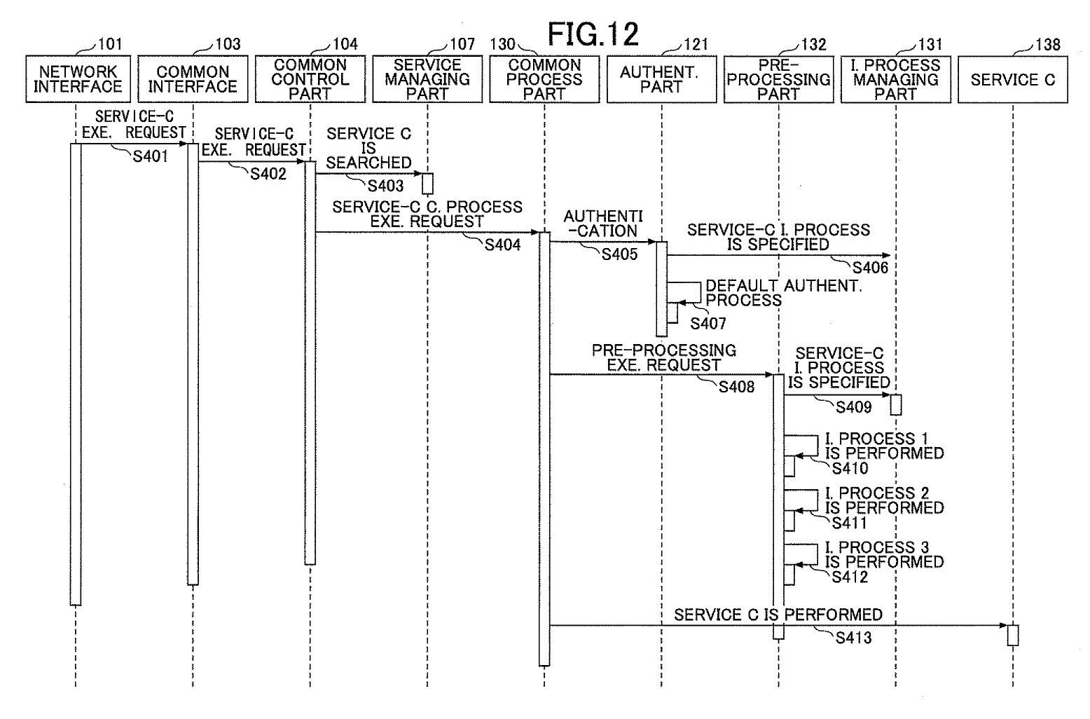

FIG. 12 is a sequence diagram for explaining the service C process which is performed by the image processing device of the second embodiment.

Steps S401 to S405 illustrated in FIG. 12 are essentially the same as the steps S201 to S205 illustrated in FIG. 8 (or FIG. 11) respectively, and a description thereof will be omitted. Exceptionally, in step S404, the common control part 104 sends a common process execution request of the service C to the common process part 130 because a service-C common process part does not exist in the service framework 102.

As illustrated in FIG. 12, in step S406, the authentication part 121 sends an inquiry about which individual process is to be performed for authentication of the service C to the individual-process managing part 131. In this embodiment, an individual process of authentication of the service C is not associated, and, in step S407, the authentication part 121 performs a default authentication process for the service C. The default authentication process is set up beforehand.

Alternatively, the service C process of FIG. 12 may be arranged so that no authentication process is performed, instead of performing the default authentication process.

In step S408, the common process part 130 sends a pre-processing execution request to the pre-process part 132. In step S409, the pre-process part 132 sends an inquiry about which pre-processing is to be performed for the service C to the individual-process managing part 131, and determines which pre-processing is to be performed.

In steps S410-S412, the pre-process part 132 performs the individual processes of the pre-processing, the processing order of which is specified as registered in the individual-process management data.

After the pre-processing is performed, in step S413, the common process part 130 sends an execution request of the service C to the service C 138, so that the service C is performed.

As mentioned above, according to the image processing device of the second embodiment, the individual processes can be implemented in the common processes as plug-ins, and the pre-processing and the post-processing needed before and after a service is performed can be implemented as individual processes for the service in the common processes of the service.

Next, an image processing device of a third embodiment of the present disclosure will be described.

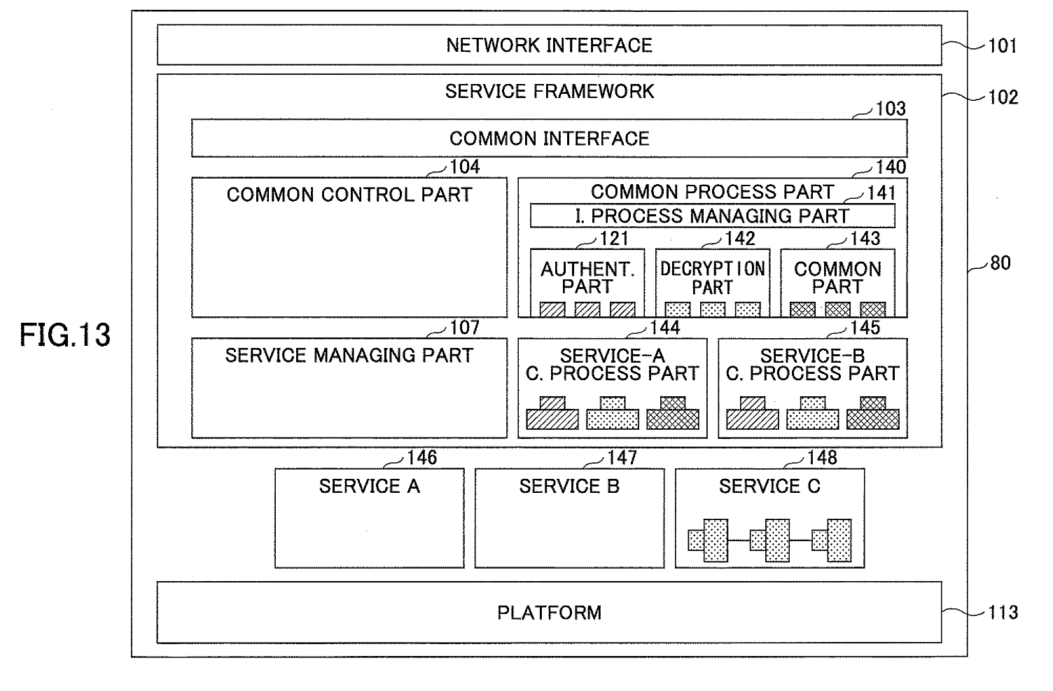

FIG. 13 illustrates the functional composition of an image processing device 80 of the third embodiment. In FIG. 13, the elements which are essentially the same as corresponding elements in FIG. 5 are designated by the same reference numerals, and a description thereof will be omitted.

As illustrated in FIG. 13, a common process part 140 includes an individual-process managing part 141, the authentication part 121, a decryption part 142, and a common part 143.

The decryption part 142 performs individual processes of the processing which decrypts the encrypted data. For example, the decryption part 142 performs a dispatch processing related to the decryption and a necessary minimum error processing.

For example, when a common process in the processing of the authentication part 121 and the decryption part 142 exists, the common part 143 is provided to specify the common process independently. For example, an error processing which is performed when the required parameters are not presented is the common process for the authentication part 121 and the decryption part 142. Such processing may be implemented as the common part 143.

In the individual-process managing part 141, a service name, a service identifier, an authentication part, a decryption part, and a second common process are associated together for every service. The individual-process managing part 141 manages the individual-process management data. The second common process includes, for example, a common process which is used in common by the authentication part 121 and the decryption part 142. In this embodiment, the second common process is implemented in the common part 143. Alternatively, the second common process may be implemented as a plug-in.

In the individual-process managing part 141, an authentication part, a decryption part, and a second common process the processing order of which is specified may be registered in the individual-process management data.

The service-A common process part 144 performs an individual process of the authentication process of the service A 146 and the service-B common process part 145 performs an individual process of the authentication process of the service B 147, similar to corresponding elements in the first embodiment described above. Processing of the common part 143 may be included in each service common process part.

The service A 146 and the service B 147 are implemented as plug-ins respectively, and these services are essentially the same as corresponding elements in the first embodiment described above.

Accordingly, according to the image processing device of the third embodiment, some processes in the common processes may be newly implemented as common processes, and these common processes may be used to perform the respective services.

Next, an image processing device of a fourth embodiment of the present disclosure will be described. In the image processing device of the fourth embodiment, a marking portion is extracted from image data of a document which is received from a client, the marking portion is analyzed, and a post-processing is determined based on a result of the analysis.

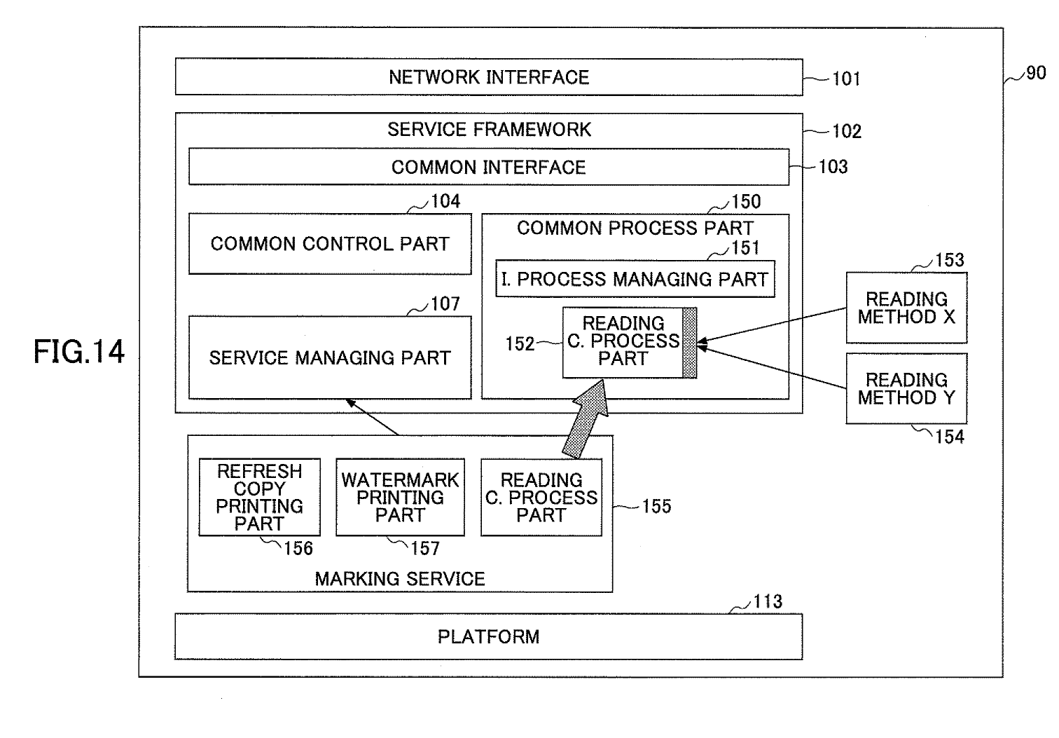

FIG. 14 illustrates the functional composition of an image processing device 90 of the fourth embodiment. In FIG. 14, the elements which are essentially the same as corresponding elements in FIG. 5 are designated by the same reference numerals, and a description thereof will be omitted.

A common process part 150 of this embodiment is arranged to perform a process which performs a standard-pattern function for respective services. As illustrated in FIG. 14, the common process part 150 includes an individual-process managing part 151 and a reading common process part 152.

In the individual-process managing part 151, respective types of marking images and their reading methods are associated together and managed. For example, in the individual-process managing part 151, a reading process of a reading method “bar code” is associated with a marking image type “bar code”.

The reading common process part 152 determines a type of a marking image of a document the processing of which is requested. The reading common process part 152 causes an individual process of a reading method corresponding to the determined marking image type to perform the reading process of the marking image. The reading common process part 152 determines a next processing based on the reading result of the individual process. The flow of this processing is specified as a common process.

A reading method X 153 and a reading method Y 154 are provided to perform individual processes of respective reading methods corresponding to different marking image types. These individual processes are newly added when it is desired to modify some contents of processing in the common process.

A marking service 155 provides a function to perform a marking service of a document based on the reading result according to the reading method. For example, the marking service 155 converts information which is to be associated with a document, into a marking image, and generates a document with the marking image embedded therein by using a superimposing method.

When a user uses the MFP (multi-function peripheral) to read the document, the MFP detects the marking image embedded in the document and restores the original information of the document. Therefore, the system is able to make use of the restored document information from the MFP. A reading method is a part which reads out a marking image from a document in which the marking image is embedded. As the reading method, any of various reading methods depending on the form and the content of the marking image may be used. Examples of the reading method may include a bar code processing, a QR (quick response) code processing, etc.

In the marking service 155, a refresh copy printing part 156 provides a marking service function which reads a marking image from a document with the marking image embedded in which a memorandum is written by hand, determines the original information of the document in response to the marking image, and prints an image of the document in which the handwritten memorandum is eliminated on a copy sheet.

In the marking service 155, a watermark printing part 157 provides a marking service function which prints a marking image as a watermark in the background of a print-out document image, instead of printing original information of the document.

Accordingly, the marking service 155 determines which of the individual processes in the marking service 155 is to be chosen as the individual process to be performed based on the result of the reading process. The marking service 155 itself may be implemented as a plug-in and the functions of the marking service 155 may be customized in the image processing device 90 after shipment. The reading common process part 152 includes an API (application programming interface) for individual processes. Therefore, the reading method may be later added as the plug-in using the API of the reading common process part 152.

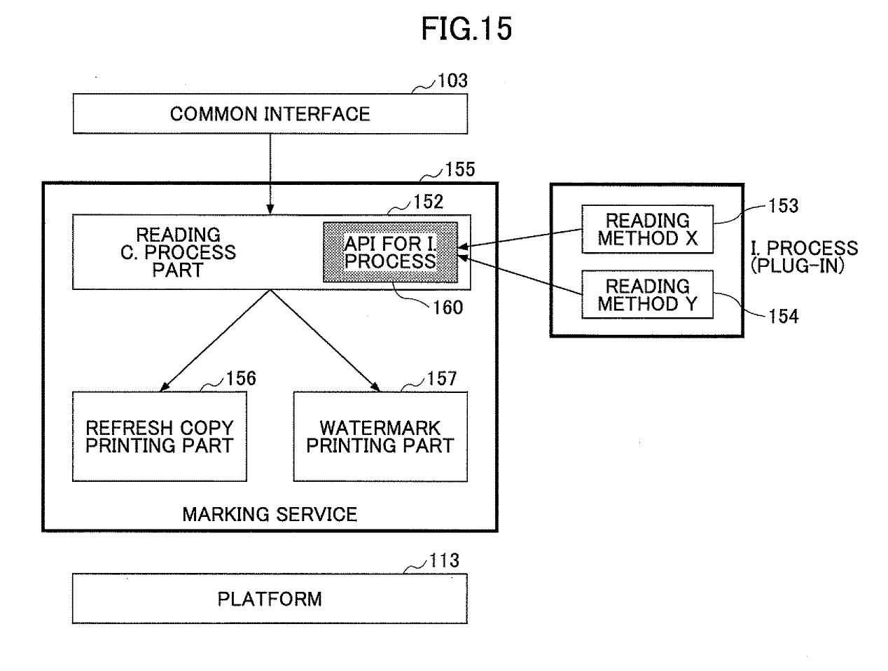

FIG. 15 is a diagram for explaining the outline of the marking service.

The method of reading a marking image differs according to the plug-in of the reading method. The reading common process part 152 determines a type of a marking image read from a document and determines which reading method is to be chosen based on the determined marking image type. For this purpose, the reading common process part 152 accesses the individual-process managing part 151 in accordance with the determined marking image type and determines which reading method is to be chosen.

The reading methods are implemented as the different plug-ins respectively. The reading common process part 152 determines which marking service is to be performed based on the reading result obtained by the determined reading method and based on the requested information, and distributes the requested process to one of the marking service parts (the printing parts 156 and 157). The reading result contains a service name indicating the next process and service-related parameters. Hence, the reading common process part 152 determines which marking service (for example, refresh copy printing or watermark printing) is to be performed based on the service name contained in the reading result.

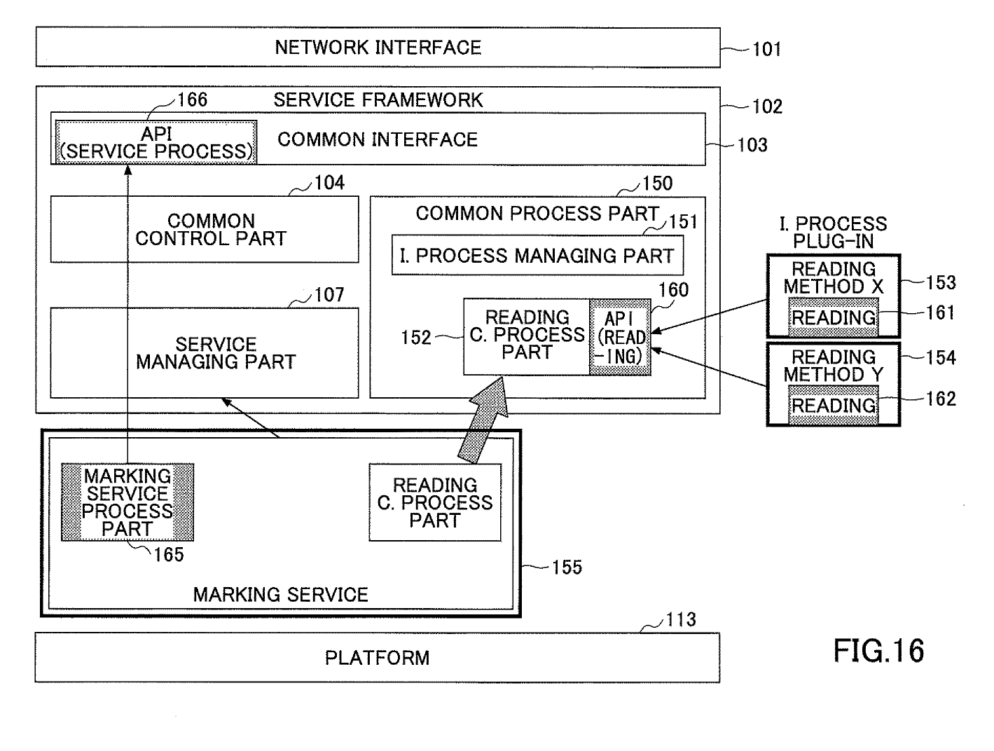

Next, the plug-in used in this embodiment will be described. FIG. 16 is a diagram illustrating an example of the plug-in in the fourth embodiment. As illustrated in FIG. 16, an individual process plug-in 153, an individual process plug-in 154, and a marking service plug-in 155 are used in the fourth embodiment.

First, the marking service plug-in 155 will be described. In the marking service plug-in 155, a marking service process part 165 is a service process part which is inherited from the interface (an API 166 for service processes) defined in the common interface 103 of the service framework 102. The marking service process part 165 is implemented in the marking service plug-in 155. In the example of FIG. 16, the marking service is implemented as the plug-in in this manner.

Next, the individual process plug-in 153 and the individual process plug-in 154 will be described. Each of the individual process plug-ins 153 and 154 is inherited from the API 160 for individual processes defined in the common process part 150. The individual process plug-in 153 and the individual process plug-in 154 are implemented as the plug-ins. Specifically, in the example of FIG. 16, the API 160 is provided in the reading common process part 152 of the common process part 150, and the individual processes for respective reading methods may be added using the API 160. Providing the API 160 in the reading common process part 152 as illustrated in FIG. 16 enables the following process to be performed.

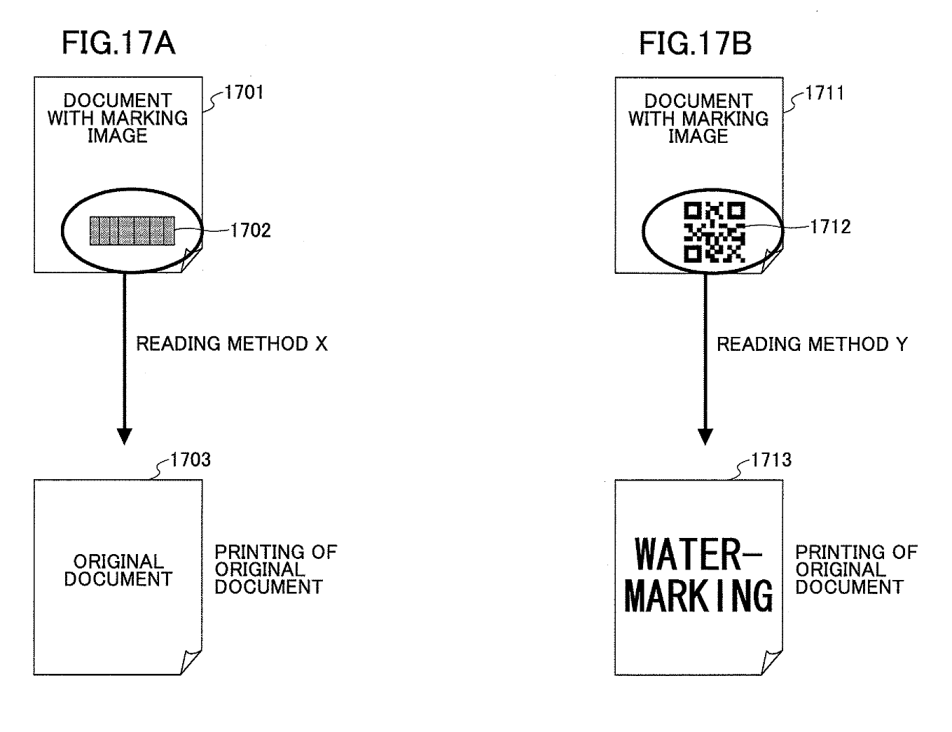

FIG. 17A and FIG. 17B illustrate examples of individual processes for different reading methods. FIG. 17A illustrates an example of an individual process for a reading method X. It is assumed that a service name “refresh copy printing” is embedded in a marking image 1702 of a document 1701 illustrated in FIG. 17A. The reading method X illustrated in FIG. 17A is to perform the bar code reading process.

The common process part 150 determines a type of the marking image 1702 read from the document 1701 as being a bar code and determines that the reading method X is to be chosen. The common process part 150 reads the marking image 1702 from the document 1701 using the reading method X, and reads the service name “refresh copy printing” from the marking image 1702. Thereby, the marking service 155 is caused to perform the refresh copy printing to print an original document image 1703.

It is assumed that a service name “watermarking” and a parameter “confidential” are embedded in a marking image 1712 of a document 1711 illustrated in FIG. 17B. The reading method Y illustrated in FIG. 17B is to perform the QR code reading process.

The common process part 150 determines a type of the marking image 1712 read from the document 1711 as being a QR code and determines that the reading method Y is to be chosen. The common process part 150 reads the marking image 1712 from the document 1711 using the reading method Y and reads the service name “watermarking” and the parameter “confidential” from the marking image 1712. Thereby, the marking service 155 is caused to perform the watermark printing which prints a watermarking of the read parameter “confidential” in the background of a print-out document image 1713, instead of printing original information of the document 1711.

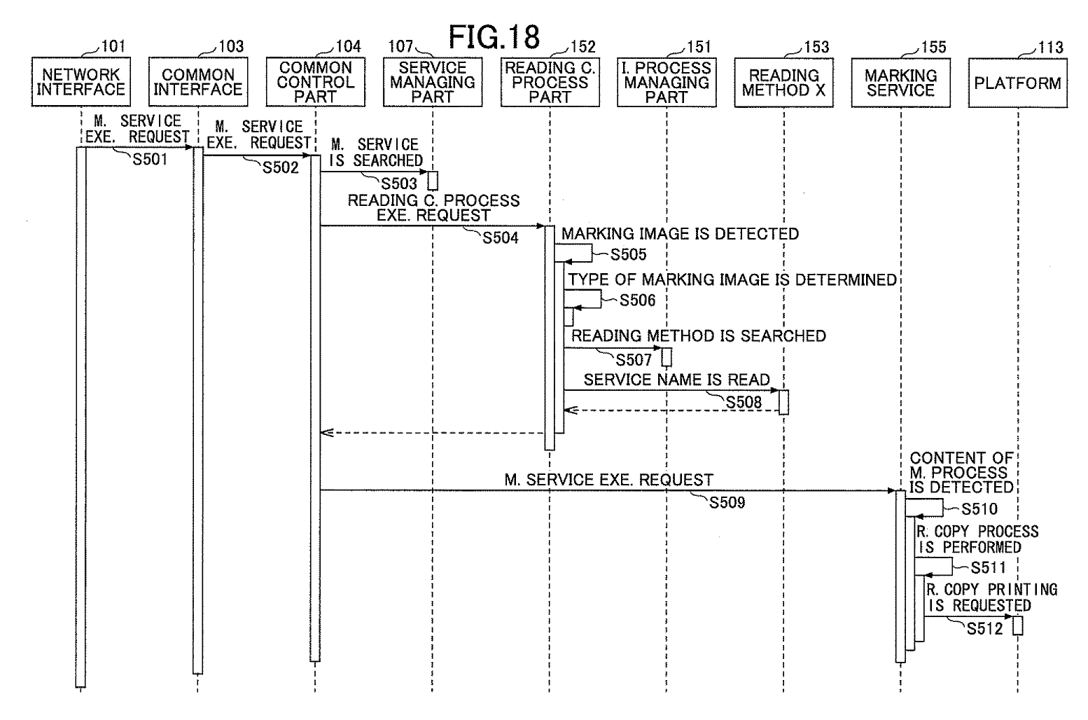

Next, operation of the image processing device of the fourth embodiment will be described. FIG. 18 is a sequence diagram for explaining a marking service process which is performed by the image processing device 90 of the fourth embodiment.

As illustrated in FIG. 18, when a document with a marking image embedded therein is received from a client via the network, in step S501, the network interface 101 of the image processing device 90 sends a marking service execution request with the received document to the common interface 103.

After the marking service execution request is received from the network interface 101, in step S502, the common interface 103 sends a marking service execution request with the document to the common control part 104.

After the marking service execution request is received from the common interface 103, in step S503, the common control part 104 searches the marking service in the service managing part 107. The service managing part 107 manages the marking service and manages the reading common process part 152 associated with the marking service.

In step S504, the common control part 104 sends a reading common process execution request with the document to the reading common process part 152.

In step S505, the reading common process part 152 detects a marking image read from the document. The reading common process part 152 detects the marking image based on the form and size of the marking image read from the document. In step S506, the reading common process part 152 determines a type of the detected marking image. In step S507, the reading common process part 152 searches a reading method corresponding to the determined marking image type in the individual-process managing part 151.

In step S508, the reading common process part 152 reads a service name and/or a parameter from the marking image read by the searched reading method (in this case, the reading method X 153) corresponding to the marking image type. The reading common process part 152 outputs the read service name and/or the read parameter to the common control part 104.

In step S509, the common control part 104 sends a marking service execution request to the marking service 155 together with the service name and/or the parameter which are received from the reading common process part 152.

In step S510, the marking service 155 determines a marking processing based on the contents of the received service name and/or the received parameter. It is assumed in this case that the service name read by the reading method X (the bar code reading process) is a refresh copy printing.

In step S511, the marking service 155 performs a refresh copy printing process based on the received service name.

In step S512, the marking service 155 outputs a printing command to the platform 113 in order to print a refreshed document image of the document.

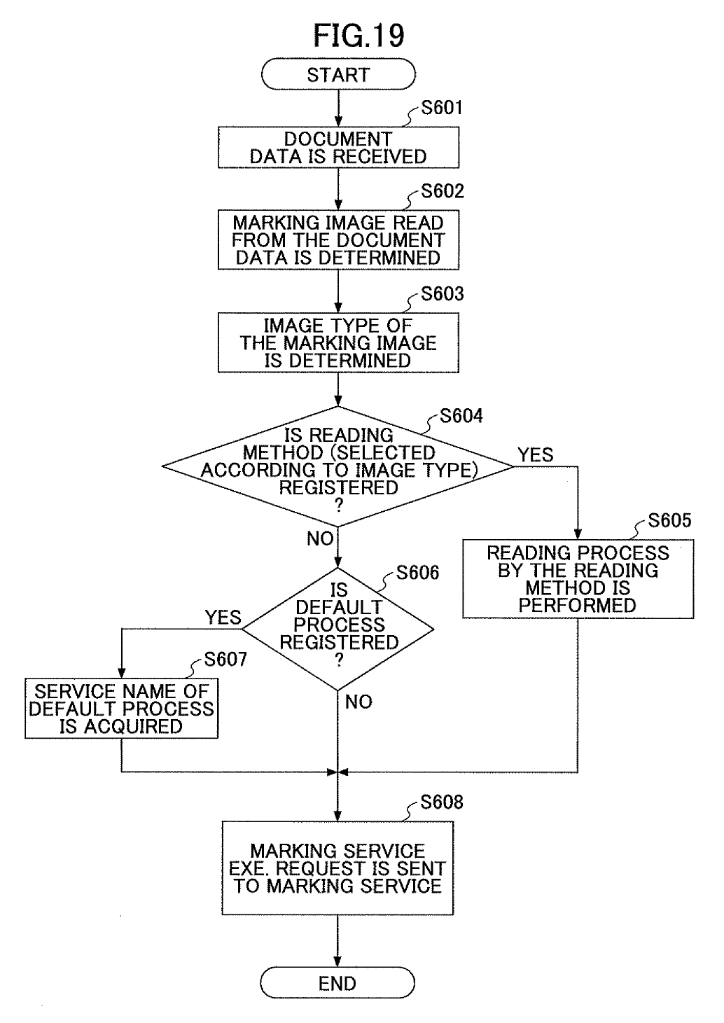

FIG. 19 is a flowchart for explaining the process which determines individual processes in the common processes.

As illustrated in FIG. 19, in step S601, the reading common process part 152 receives data of a document with a marking image embedded.

In step S602, the reading common process part 152 determines a marking image read from the document data with the marking image embedded. In step S603, the reading common process part 152 determines a type of the read marking image. For example, the reading common process part 152 determines whether the marking image is a bar code or a QR code.

In step S604, the reading common process part 152 determines whether a reading method corresponding to the type of the read marking image is registered in the individual-process managing part 151. When the reading method is registered in the individual-process managing part 151, the control is transferred to step S605. When the reading method is not registered in the individual-process managing part 151, the control is transferred to step S607. The corresponding reading method being registered in the individual-process managing part 151 means that individual processes are provided in the common process part 150.

In step S605, the reading common process part 152 performs the reading process defined by the corresponding reading method using the API 160 for individual processes. A service name and/or a parameter contained in a reading result of the reading process performed are output from the reading common process part 152 to the common control part 104.

In step S606, the reading common process part 152 determines whether a default process is registered beforehand in the common process part 150.

When the default process is registered, the control is transferred to step S607. When the default process is not registered, the control is transferred to step S608.

In step S607, the reading common process part 152 acquires a service name of the default process. The service name acquired is output from the reading common process part 152 to the common control part 104.

In step S608, the common control part 104 sends a marking service execution request (containing the document and the service name and/or the parameter) to the marking service 155.

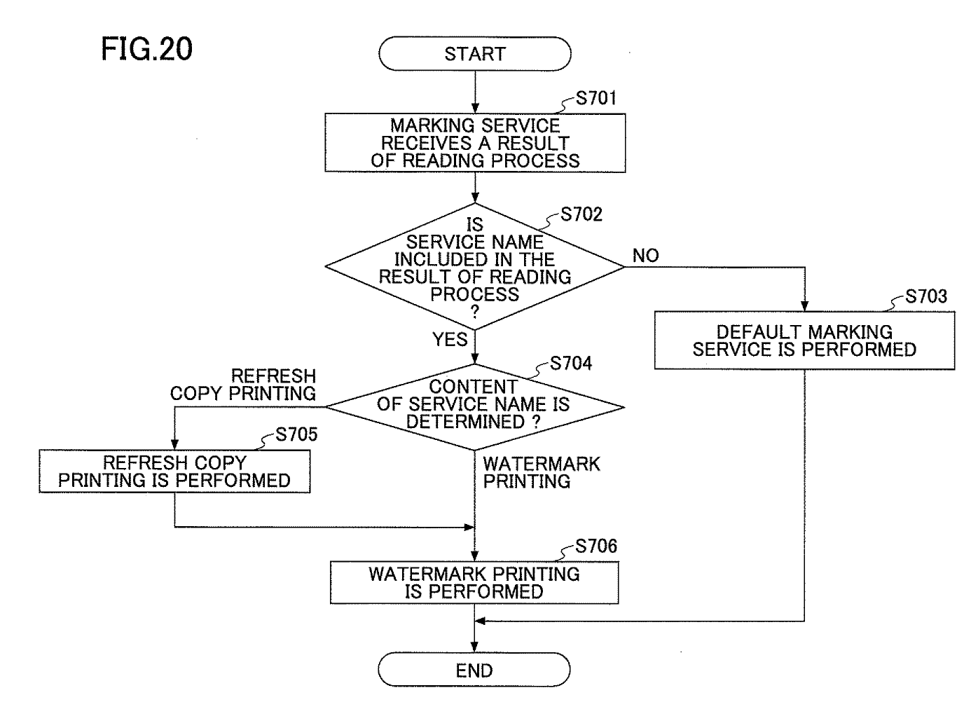

FIG. 20 is a flowchart for explaining a marking service process which is performed by the image processing device 90 of the fourth embodiment.

As illustrated in FIG. 20, in step S701, the marking service 155 receives the document data (with the marking image embedded) and the service name which are obtained as a result of the reading process, from the common control part 104. There may be a case in which the service name and/or the parameter as a result of the reading process are not received from the common control part 104.

In step S702, the marking service 155 determines whether the service name is included in the result of the reading process. When the service name is included, the control is transferred to step S704. When the service name is not included, the control is transferred to step S703.

In step S703, the marking service 155 performs a default marking service which is defined beforehand in the marking service 155.

In step S704, the marking service 155 determines the content of the service name. For example, the marking service 155 determines whether the content of the service name is “refresh copy printing” or “watermark printing”. Alternatively, the marking service 155 may determine whether the content of the parameter indicates “refresh copy printing” or “watermark printing”.

When the content of the service name is “refresh copy printing”, the control is transferred to step S705. When the content of the service name is “watermark printing”, the control is transferred to step S706.

In step S705, the marking service 155 performs the refresh copy printing by using the refresh copy printing part 156.

In step S706, the marking service 155 performs the watermark printing by using the watermark printing part 157. At this time, the marking service 155 may print the parameter read by the reading method Y (QR code reading process) as a watermark.

The marking service 155 may be provided to include another marking service part other than the refresh copy printing part 156 and the watermark printing part 157. It is not necessary that the marking service 155 in the fourth embodiment is a marking service. Alternatively, the marking service may be replaced with another service.

According to the image processing device of the fourth embodiment, when adding a new function for processing a marking image or adding a new condition, such as a modification of a post-processing after a marking image is read, a new reading method may be added to the common process part using the API. Therefore, the addition of the new function or condition can be carried out without substantially changing the common process part.

The content of a next process and a parameter of the next process may be embedded in a marking image, and the reading process which reads the marking image can be implemented as an individual process.

When a new marking process is added to the common process part, the new marking process can be added using the API of the common process part. The new marking process provides, for example, an illegal copy guard detection service. The illegal copy guard detection service is a service which reads a marking image from a document with the marking image embedded and restricts operation being conducted to the document based on the read marking image.

According to the related art, the contents of processing in the marking service after the common process is performed are fixed. Therefore, if it is desired to change the flow of the contents of the processing, the related art requires adding a new marking service to the system. In order to change the contents of processing in the marking service, it is necessary for the marking service to perform the process as illustrated in FIG. 19. However, the portion of the software in which the same processes are performed must be developed in a duplicate manner. As a result, the time and effort for the development of the duplicate software have been spent in vain.

To eliminate the problem, in the image processing device of the fourth embodiment, the process part for performing the individual process which is common to the respective services is arranged in the common process part 150. It is possible to avoid the wasted effort and time for the development according to the related art. Because the individual processes in the common process part can be implemented as plug-ins, and the flow of the processing can be changed in a flexible manner.

As described in the foregoing, according to the present disclosure, it is possible to provide an image processing device, an information processing method, and a computer-readable recording medium which are capable of customizing individual processes for respective services in common processes of Web services.

The present disclosure is not limited to the above-described embodiments, and variations and modifications may be made without departing from the scope of the present disclosure.

The present application is based on Japanese patent application No. 2009-212449, filed on Sep. 14, 2009, and Japanese patent application No. 2010-114672, filed on May 18, 2010, the contents of which are incorporated herein by reference in their entirety.

What is claimed is:

1. An image processing device which is configured to use plug-ins to provide services, comprising:
a service managing part to manage services, plug-ins of which are implemented;
a common control part to control common processes of a requested service in response to a service execution request with respect to one of the services;
a common process part to perform common processes for the respective services; and
an individual process part to perform an individual process in the common processes, the individual process being implemented as a plug-in,
wherein the common process part includes an individual-process managing part which manages the individual process associated with one of the services.

2. The image processing device according to claim 1, further comprising an authentication part provided in the common process part to perform an authentication process as one of the common processes, the authentication part being configured to perform a default authentication process when a plug-in of the individual process is not registered in the individual-process managing part.

3. The image processing device according to claim 2, further comprising:
a pre-processing part to perform a pre-processing before the authentication process is performed; and
a post-processing part to perform a post-processing after the authentication process is performed,
wherein the individual-process managing part is configured to manage the pre-processing and the post-processing each of which is associated with one of the services.

4. The image processing device according to claim 3, wherein the individual-process managing part is configured to manage the pre-processing and the post-processing a processing order of which is specified.

5. The image processing device according to claim 1, further comprising a service process part to receive a processing result of the common process of the requested service and to determine a service corresponding to the processing result.

6. The image processing device according to claim 5, wherein the processing result of the common process includes a service name and a service-related parameter, and the service process part performs a service identified by the service name based on the service-related parameter.

7. The image processing device according to claim 5, further comprising a common interface part to provide an interface common to the respective services, the common interface part including an API for adding a plug-in of a service,
wherein the common process part includes an API for adding a plug-in of an individual process.

8. An information processing method for use in an image processing device which is configured to use plug-ins to provide services and includes a service managing part which manages services, plug-ins of which are implemented, and an individual-process managing part which manages an individual process in common processes for the respective services, the information processing method comprising:
receiving, by a common control part, a service execution request with respect to one of the services;
searching, by the common control part, the one of the services in the service managing part and searching an individual process part associated with the one of the services in the service managing part;
sending, by the common control part, a common process execution request to the individual process part;
causing, by the individual process part, a common process part to perform common processes of the one of the services;
determining, by the common process part, which individual process is to be performed by accessing the individual-process managing part;
performing, by the individual process part, the individual process; and
causing, by the individual process part, a service part to perform the one of the services.

9. A computer-readable recording medium storing a program which, when executed by a computer, causes the computer to perform an information processing method for use in an image processing device which is configured to use plug-ins to provide services and includes a service managing part which manages services, plug-ins of which are implemented, and an individual-process managing part which manages an individual process in common processes for the respective services, the information processing method comprising:
receiving, by a common control part, a service execution request with respect to one of the services;
searching, by the common control part, the one of the services in the service managing part and searching an individual process part associated with the one of the services in the service managing part;
sending, by the common control part, a common process execution request to the individual process part;
causing, by the individual process part, a common process part to perform common processes of the one of the services;
determining, by the common process part, which individual process is to be performed by accessing the individual-process managing part;
performing, by the individual process part, the individual process; and
causing, by the individual process part, a service part to perform the one of the services.
